(19) United States
(12) Patent Application Publication
(10) Pub. No.: US 2013/0014392 A1
(43) Pub. Date: Jan. 17, 2013

(54) CUTTING TOOL WITH ADJUSTABLE CUTTING ANGLE

(71) Applicant: Kun-Meng Lin, Changhua County (TW)

(72) Inventor: Kun-Meng Lin, Changhua County (TW)

(21) Appl. No.: 13/181,537

(22) Filed: Jul. 13, 2011

(51) Int. Cl. B26B 17/00

(52) U.S. Cl. 30/179

(57) ABSTRACT

A cutting tool with an adjustable cutting angle includes a first shank ended by a cutting blade, a second shank pivotally connected to the first shank so that the first and second shanks can be drawn toward or away mutually, an anvil provided on the second shank in positional correspondence to the cutting blade so as to work with the cutting blade and cut, wherein the anvil having a board-like body extending along the second shank is formed with an axial hole and edged with a curved sliding rim, and a pivotable retaining plate having its one end mounted around a shaft in the axial hole and its opposite end formed with a notch for engaging with the sliding rim, so that the pivotable retaining plate can pivot against the anvil, thereby making an angle between the retaining plate and the cutting blade, namely the cutting angle vary.

### BACKGROUND OF THE INVENTION

1. Technical Field

The present invention relates to cutting tools, and more particularly, to a scissors-like cutting tool that is adjustable to cut workpiece with cut edges of different angles.

2. Description of Related Art

U.S. Pat. No. 5,542,182 has disclosed a cutting tool providing a variable cutting angle by using a cove seat to define an angle between a workpiece and a blade of the cutting tool. However, adjusting the cutting angle of the known device is structurally and operationally complicated. The complexity in structure not only makes fabrication of the tool difficult, but also tends to cause malfunction during use. In addition, for preventing interference between the blade and the cove seat, only a few particular angles are available. Hence, there is a need to improve the known device.

### SUMMARY OF THE INVENTION

In view of the foregoing shortcomings of the prior art, the present invention proposes a cutting tool with an adjustable cutting angle.

According to the present invention, the cutting tool includes a first shank having one end provided with a cutting blade; a second shank being pivotally connected with the first shank; an anvil provided at one end of the second shank, so as to work with the cutting blade to cut, wherein the anvil has a board-like body extending along the second shank, and the anvil is formed with an axial hole and a curved sliding rim; and a pivotable retaining plate having one end provided with a shaft configured to be received in the axial hole and an opposite end formed with a notch for engaging with the sliding rim, so that the pivotable retaining plate is allowed to move over the anvil, thereby changing an angle between the pivotable retaining plate and the cutting blade, namely the cutting angle.

One objective of the present invention is that the mechanism formed by the pivotable retaining plate shaft and the notch allow the angle between the pivotable retaining plate and the cutting blade to be varied, so that a workpiece abutting against the pivotable retaining plate can be cut with a desired cutting angle, wherein the mechanism is simple in structure, easy in fabrication and reliable in use, thus being advantageous.

Another objective of the present invention is that the anvil is formed with a row of angle-setting holes arranged along the sliding rim, and the pivotable retaining plate has a angle-setting clamp that is near the notch and configured to position the pivotable retaining plate with respect to the sliding rim, in which the angle-setting clamp includes a fixing end for being removably engaged with the angle-setting hole so that the pivotable retaining plate can be positioned via one of the angle-setting holes, thereby realizing quick and convenient cutting-angle adjustment.

Yet another objective of the present invention is that the cutting blade is replaceable, and the second shank has a pivotable second handle, which is formed with a blade nest for storing spare cutting blades, so as to allow convenient replacement or storage of the cutting blade.

### BRIEF DESCRIPTION OF THE DRAWINGS

The invention as well as a preferred mode of use, further objectives and advantages thereof will be best understood by reference to the following detailed description of and illustrative embodiment when read in conjunction with the accompanying drawings, wherein:

FIG. 1 is a perspective view of a cutting tool of the present invention;

FIG. 2 is an exploded view of the cutting tool of the present invention;

FIGS. 3 and 4 illustrate operation of an angle-setting clamp of the cutting tool of the present invention;

FIGS. 5 and 6 illustrate cutting-angle adjustment of the present invention; and

FIG. 7 illustrates replacement and storage of the disclosed cutting tool's cutting blade.

### DETAILED DESCRIPTION OF THE INVENTION

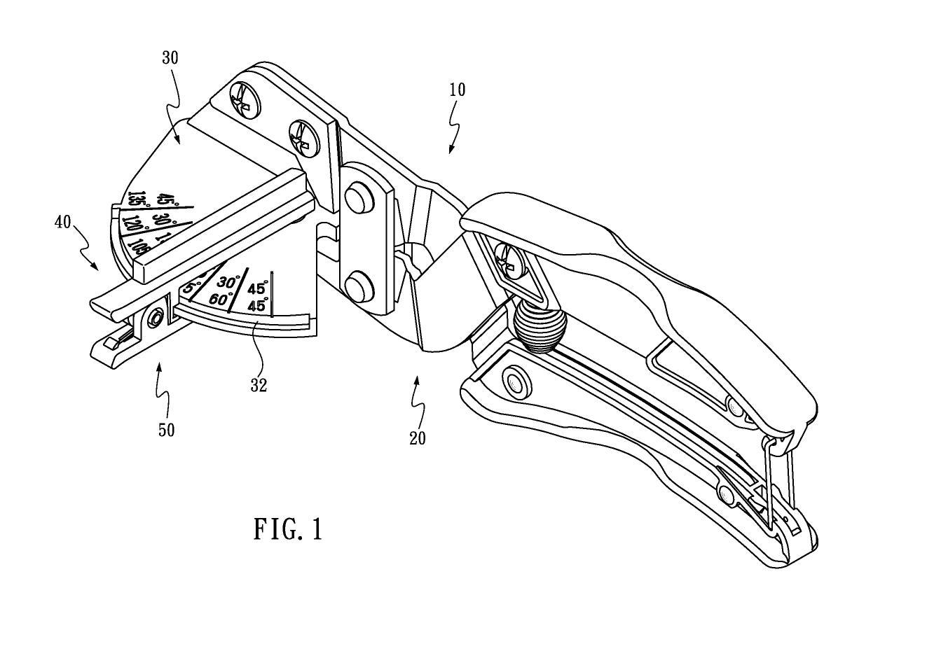

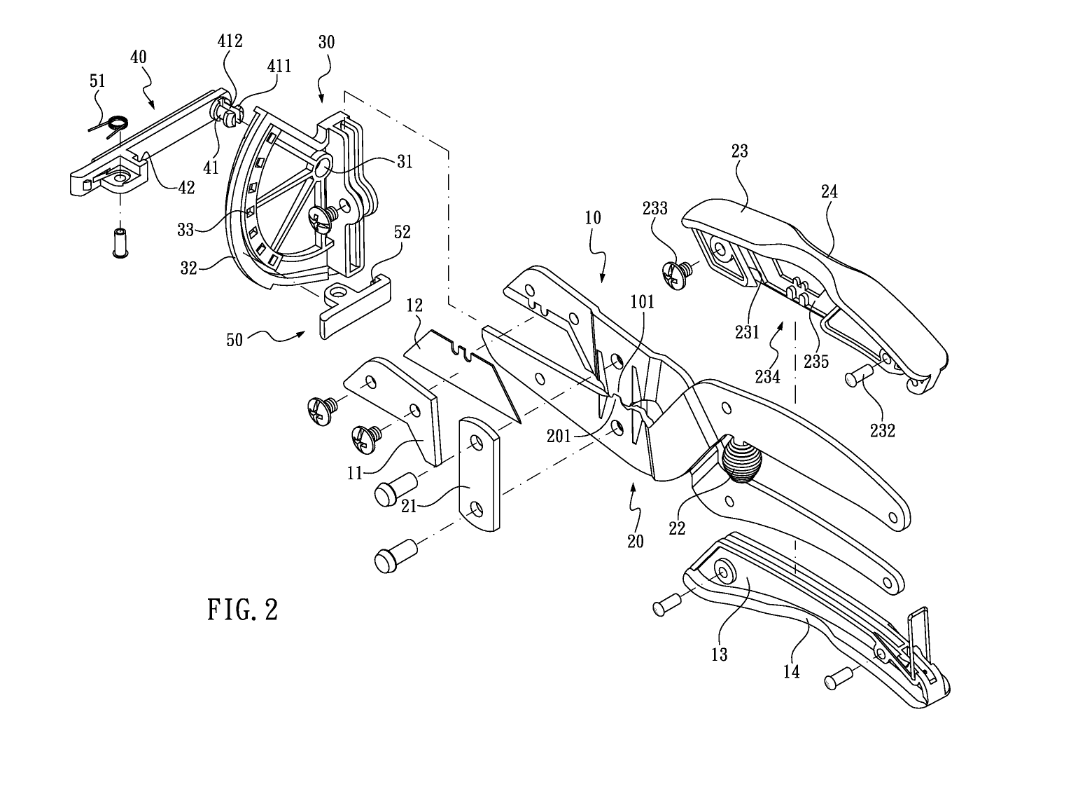

Referring to FIG. 1 and FIG. 2, according to the present invention, a cutting tool with an adjustable cutting angle includes a first shank 10, a second shank 20, an anvil 30, a pivotable retaining plate 40 and an angle-setting clamp 50.

The first shank 10 has one end movably combined with a cutting blade 12 through a connecting plate 11 and the first shank 10 has an opposite end provided with a first handle 13 for a user to hold. The first handle 13 is formed with a recessed section 14.

The second shank 20 and the first shank 10 are closely combined by plural teeth 101 and 201. At least one linking member 21 with two ends pivotally connected to the first shank 10 and the second shank 20 is provided next to the teeth 101, 201. A spring 22 is arranged between the first shank 10 and the second shank 20 so as to define the span between the first shank 10 and the second shank 20. The second shank 20 has one end far from the cutting blade 12 provided with a second handle 23 for a user to hold. The second handle 23 has its inner side depressed to form a handle trough 231 for receiving the second shank 20. The second handle 23 has two ends connected to the second shank 20 through a pivot 232 and a fixing member 233, respectively. The inner side of the second handle 23 is further provided with an opening 234 and a blade nest 235 for receiving the cutting blade 12. The second handle 23 also has a recessed section 24.

The anvil 30 is movably fixed to the second shank 20 and is adjacent to the cutting blade 12, so as to perform cutting with cooperation of the cutting blade 12. Therein, the anvil 30 has a board-like body extending along the second shank 20 and is formed with an axial hole 31. The anvil 30 has one side formed with a curved sliding rim 32, and a set of graduations is radially distributed on the anvil 30 centered the axial hole 31. Moreover, the anvil 30 has a row of angle-setting holes 33 arranged along the sliding rim 32.

The pivotable retaining plate 40 is made of an elastic material, such as plastic, with one of its ends provided with a shaft 41 configured to be fitted in the axial hole 31. The shaft 41 is terminated with a diametrically enlarged head 411, and has at least one elastic slot 412, so as to allow the shaft 41 to be fitted into the axial hole 31 and engage with the axial hole 31 in virtue of the head 411. The pivotable retaining plate 40 has the other end made with a notch 42 configured to match the sliding rim 32, so that the pivotable retaining plate 40 is allowed to pivot on the anvil 30, thereby changing the relative angle between the pivotable retaining plate 40 and the cutting blade 12.

The angle-setting clamp 50 is pivotally connected to the pivotable retaining plate 40 at the end where the notch 42 is provided. A spring element 51 is provided between the angle-setting clamp 50 and the pivotable retaining plate 40, so as to make the angle-setting clamp 50 removably fixed outside the anvil 30. The angle-setting clamp 50 has a fixing end 52 that is configured to be removably inlaid in the angle-setting hole 33.

With the configuration given above, the present invention operates in the manner described below.

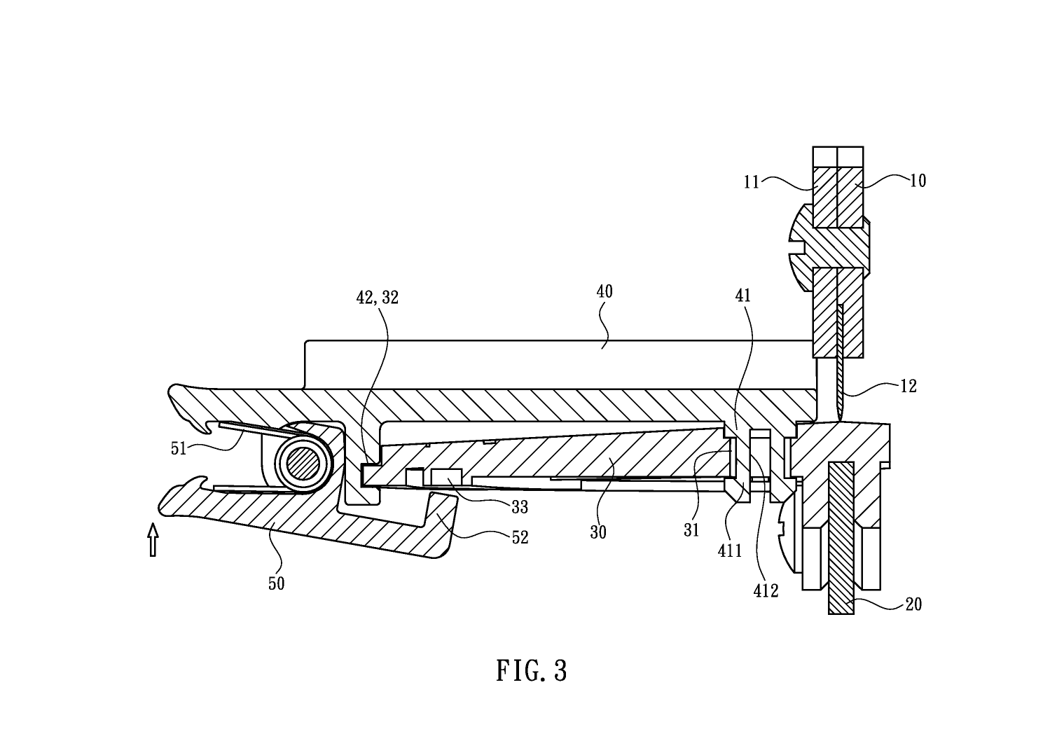

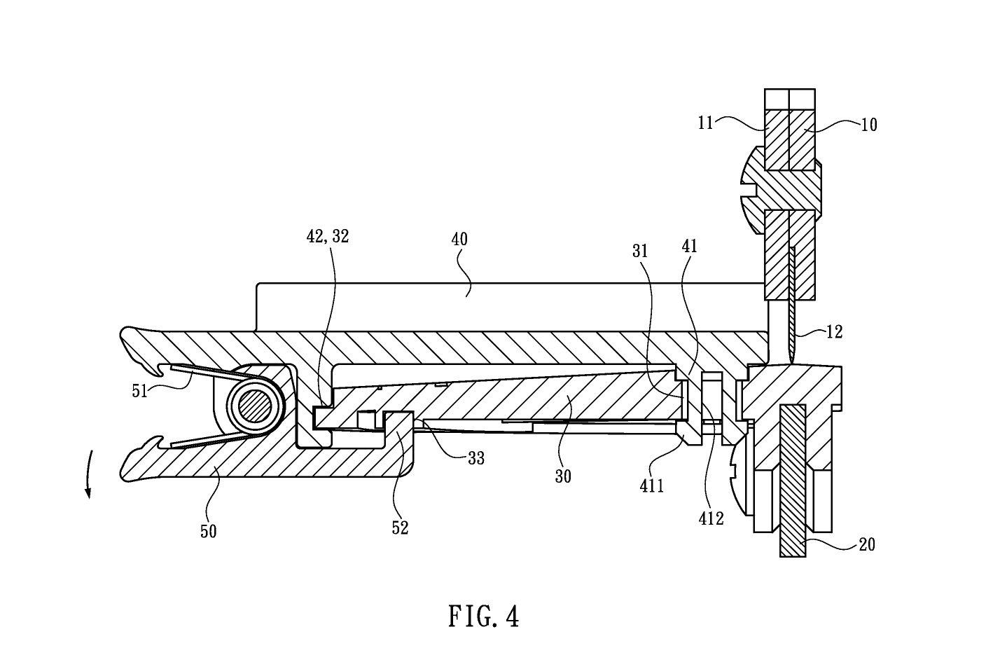

Referring to FIG. 3, when it is desired to adjust the cutting angle, a user may press the angle-setting clamp 50 to separate the fixing end 52 from the angle-setting hole 33, so that the pivotable retaining plate 40 is released and pivotable. Then the user can move the pivotable retaining plate 40 at the end having the notch 42 along the sliding rim 32 to a desired position and release the angle-setting clamp 50. At this time, the spring element 51 makes the fixing end 52 reengage with one of the angle-setting hole 33 (as shown in FIG. 4). The angle-setting holes 33 are formed to provide particular frequently-used angles so as to facilitate quick setting. However, even at a place where no angle-setting hole is provided, the angle-setting clamp 50 itself is sufficient to fixing the pivotable retaining plate 40 there by its clamping force.

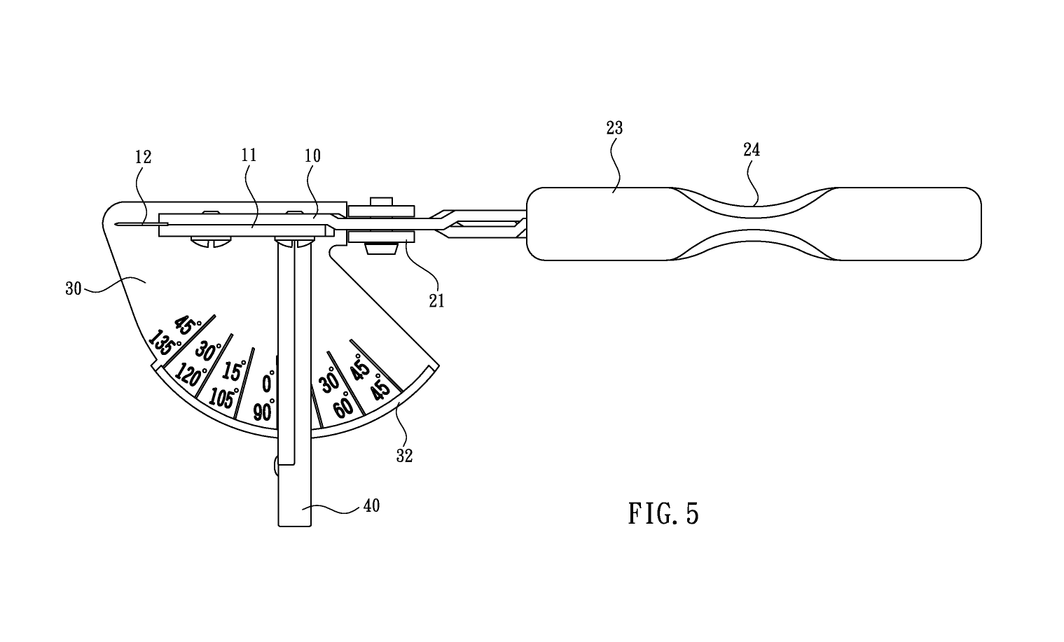

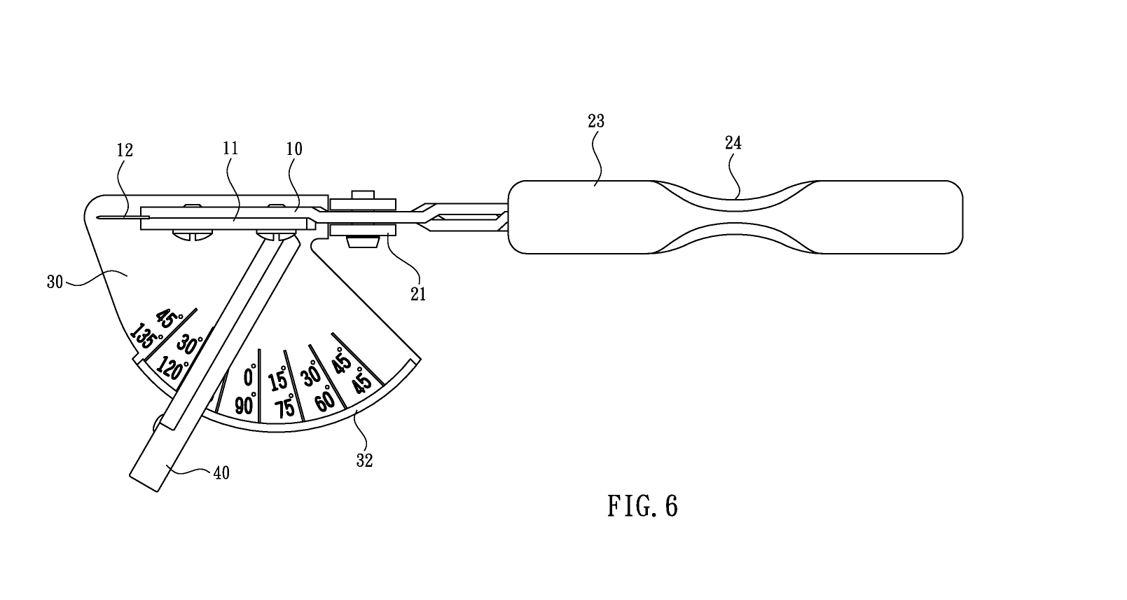

As shown in FIG. 5 and FIG. 6, when the angle between the pivotable retaining plate 40 and the cutting blade 12 is properly set for providing a desired cutting angle, the user may abut a workpiece against the pivotable retaining plate 40, and squeeze the first handle 13 and the second handle 23 together, so that the cutting blade 12 can cut the workpiece against the anvil 30 and form a cutting edge on the workpiece with the set angle. Therein, engagement between the teeth 101 and 201 allows effective transmission and thereby enables the user to cut the workpiece with reduced force. In addition, the recessed. sections 14 and 24 are designed to fit the user's hand ergonomically, so as to facilitate the user's holding and operating the tool.

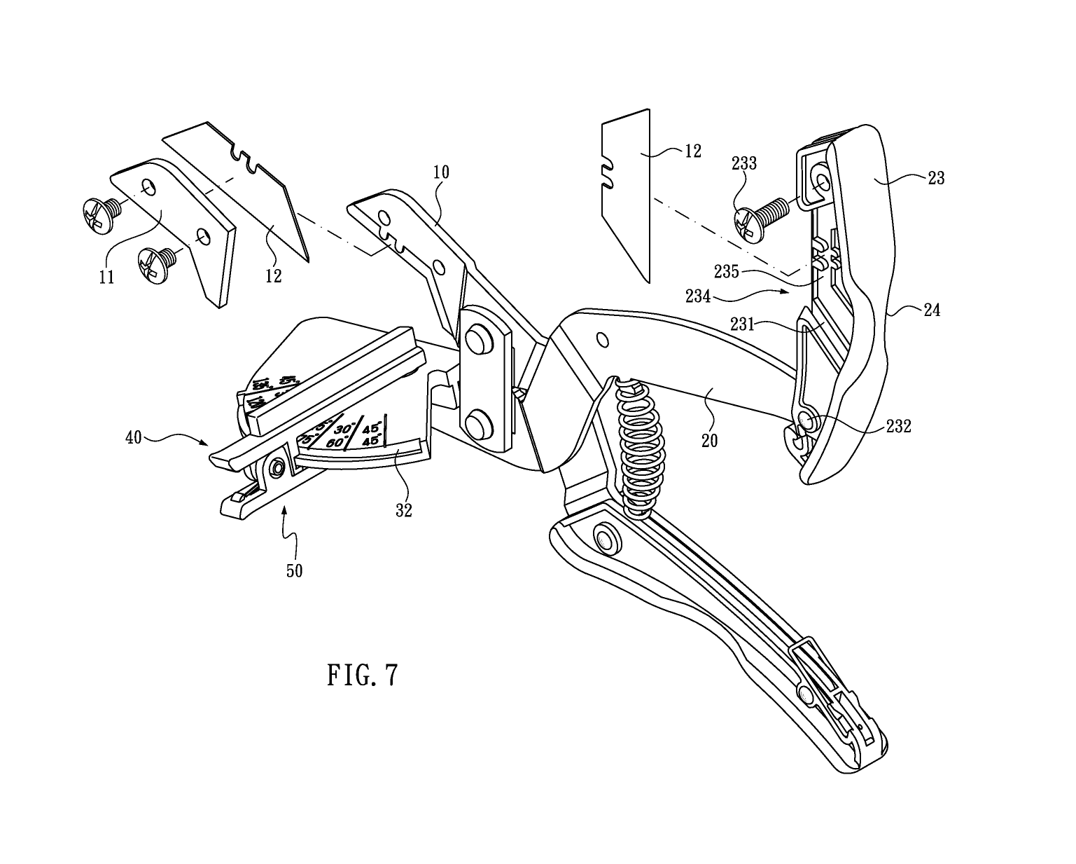

As shown in FIG. 7, replacement of the cutting blade 12 can be easily achieved after removal of the connecting plate 11. Moreover, after the fixing member 233 is removed from the second handle 23, the second handle 23 is allowed to rotate on the pivot 232, so as to expose the blade nest 235 in the handle trough 231 outside the second shank 20, so that a spare cutting blade 12 pre-stored in the blade nest 235 can be accessed and taken out through the opening 234 to complete the replacement. When the tool is not in use, the cutting blade 12 may be removed and stored in the blade nest 235 before the second handle 23 is restored and the fixing member 233 is installed again. At this time, the blade nest 235 is covered by the second shank 20, and the cutting blade 12 stored therein is secured from accidentally escape.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A cutting tool with an adjustable cutting angle, comprising:
a first shank having one end provided with a cutting blade;
a second shank being pivotally connected with the first shank;
an anvil provided at one end of the second shank, so as to work with the cutting blade to cut, wherein the anvil has a board-like body extending along the second shank, and the anvil is formed with an axial hole and a curved sliding rim; and
a pivotable retaining plate having one end provided with a shaft configured to be received in the axial hole and an opposite end formed with a notch for engaging with the sliding rim, so that the pivotable retaining plate is allowed to move over the anvil, thereby changing an angle between the pivotable retaining plate and the cutting blade.

2. The cutting tool as claimed in claim 1, wherein the shaft is terminated with a diametrically enlarged head and has at least one elastic slot.

3. The cutting tool as claimed in claim 1, wherein the anvil is formed with a row of angle-setting holes arranged along the sliding rim, and the pivotable retaining plate has a angle-setting clamp that is near the notch and configured to position the pivotable retaining plate with respect to the sliding rim, in which the angle-setting clamp includes a fixing end for being removably engaged with the angle-setting hole.

4. The cutting tool as claimed in claim 1, wherein the cutting blade is removably fixed to the end of the first shank via a connecting plate.

5. The cutting tool as claimed in claim 1, wherein the first shank and the second shank at ends thereof opposite to the cutting blade and the anvil provided with a first handle and a second handle for facilitating a user's holding and operating the cutting tool.

6. The cutting tool as claimed in claim 1, wherein each of the first handle and the second handle has a recessed section.

7. The cutting tool as claimed in claim 1, wherein the second handle has an inner side formed with a handle trough for receiving the second shank, and the second handle has two ends connected with the second shank via a pivot and a fixing member, respectively.

8. The cutting tool as claimed in claim 1, wherein the handle trough has a wall formed with a blade nest for storing the cutting blade.
